(19) United States
(12) Patent Application Publication
(10) Pub. No.: US 2016/0188233 A1
(43) Pub. Date: Jun. 30, 2016

(54) METHOD FOR INTERRUPTING CLEANING PROCEDURE OF FLASH MEMORY

(71) Applicant: MediaTek Inc., Hsin-Chu (TW)

(72) Inventor: Mong-Ling CHIAO, Taipei City (TW)

(21) Appl. No.: 14/632,135

(22) Filed: Feb. 26, 2015

Related U.S. Application Data
(60) Provisional application No. 62/096,917, filed on Dec. 26, 2014.

(51) Int. Cl. G06F 3/06

(52) U.S. Cl. CPC G06F 3/0619; G06F 3/0679; G06F 3/064; G06F 3/0659

(57) ABSTRACT

A controller for interfacing between a host and a flash memory is provided. The flash memory includes a plurality of data blocks and a plurality of spare blocks. The controller includes a memory unit and a computation unit. The computation unit is configured to perform a cleaning procedure of the flash memory, wherein whenever the computation unit has finished copying a valid page of a source block in the plurality of data blocks to a spare page of a destination block in the plurality of spare blocks during the cleaning procedure, the computation unit determines whether a request is coming from the host, if so, the computation unit suspends the cleaning procedure and responds to the request from the host, if not, the computation unit continues the cleaning procedure.

### CROSS REFERENCE TO RELATED APPLICATIONS

This application claims the benefit of U.S. Provisional Application No. 62/096,917 filed on Dec. 26, 2014, the entirety of which is incorporated by reference herein.

### BACKGROUND OF THE INVENTION

1. Field of the Invention

The present invention relates to a flash controller, and, in particular, to a flash controller and a method for interrupting a cleaning procedure for a NAND flash memory.

2. Description of the Related Art

Flash memory is a common non-volatile data storage device, which can be erased and programmed electrically. For example, a NAND flash memory is usually ideal for use in a memory card, a USB flash device, a solid-state disk (SSD), an embedded multimedia card, etc.

A storage array of a flash memory may comprise a plurality of blocks, and each block comprises a plurality of pages. When a used block is to be released as a spare block, all pages of the used block have to be erased in the operation. The technique of the cleaning procedure (i.e. often referred to as “garbage collection”) of flash memory is used to move the valid data located in various blocks to a spare space, so that the blocks that only contain invalid data can be erased and released as spare blocks.

### BRIEF SUMMARY OF THE INVENTION

A detailed description is given in the following embodiments with reference to the accompanying drawings.

In an exemplary embodiment, a controller for interfacing between a host and a flash memory is provided. The flash memory includes a plurality of data blocks and a plurality of spare blocks. The controller includes a memory unit and a computation unit. The computation unit is configured to perform a cleaning procedure of the flash memory. Whenever the computation unit has finished copying a valid page of a source block in the plurality of data blocks to a spare page of a destination block in the plurality of spare blocks during the cleaning procedure, the computation unit determines whether a request is coming from the host, if the request is received from the host, the computation unit suspends the cleaning procedure and responds to the request from the host, if no request is received from the host, the computation unit continues the cleaning procedure.

In another exemplary embodiment, a method for interrupting a cleaning procedure of a flash memory is provided. The flash memory includes a plurality of data blocks and a plurality of spare blocks. The method includes the steps of: determining whether a request is coming from the host whenever a valid page of a source block in the plurality of data blocks has been copied to a spare page of a destination block in the plurality of spare blocks during the cleaning procedure; if the request is received from the host, suspending the cleaning procedure and responding to the request from the host, if no request is received from the host, continuing the cleaning procedure.

In another exemplary embodiment, a data storage device is provided. The data storage device includes a flash memory and a controller. The flash memory includes a plurality of data blocks and a plurality of spare blocks. The controller is for interfacing between a host and a flash memory, and the controller includes a memory unit and a computation unit. The computation unit is configured to perform a cleaning procedure of the flash memory. Whenever the computation unit has finished copying a valid page of a source block in the plurality of data blocks to a spare page of a destination block in the plurality of spare blocks during the cleaning procedure, the computation unit determines whether a request is coming from the host, if the request is received from the host, the computation unit suspends the cleaning procedure and responds to the request from the host, if no request is received from the host, the computation unit continues the cleaning procedure.

### BRIEF DESCRIPTION OF THE DRAWINGS

The present invention can be more fully understood by reading the subsequent detailed description and examples with references made to the accompanying drawings, wherein:

FIG. 1 is a block diagram of an electronic device in accordance with an embodiment of the invention;

FIG. 2 is a diagram illustrating the copying of a valid page of a source block to a spare block of a destination block in accordance with an embodiment of the invention;

FIG. 3A is a flow chart of a conventional method for responding to the request from the host during the cleaning procedure;

FIG. 3B is a flow chart of another conventional method for responding to the request from the host during the cleaning procedure; and

FIG. 4 is a flow chart of a method for interrupting a cleaning procedure of a flash memory in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

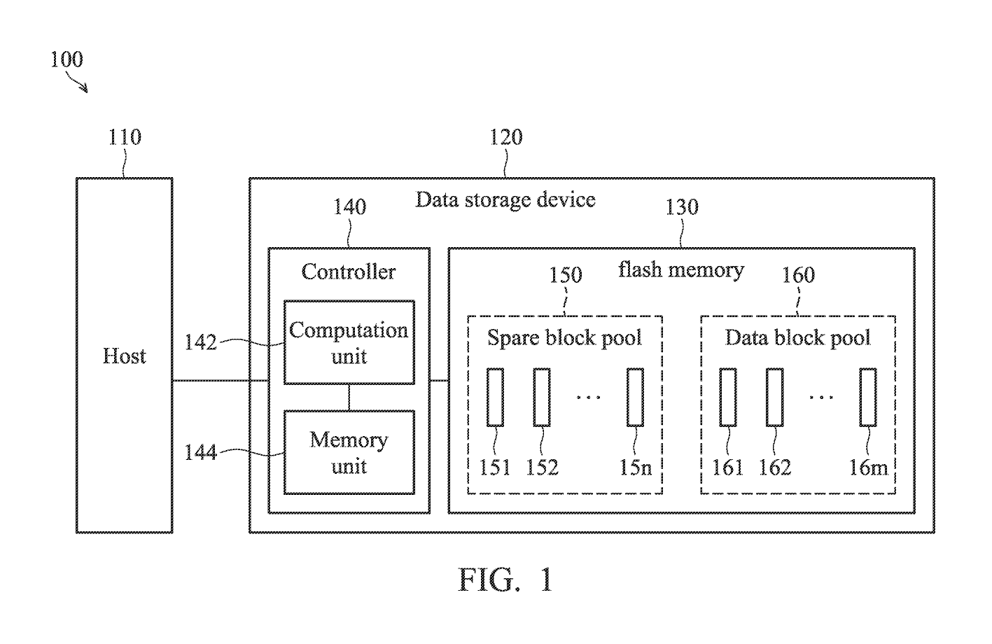

FIG. 1 is a block diagram of an electronic device in accordance with an embodiment of the invention. The electronic device 100 may comprise a host 110 and a data storage device 120. The data storage device 120 may comprise a flash memory 130 and a controller 140, wherein the controller 140 interfaces between the host 110 and the flash memory 130 and controls access to the flash memory 130 according to the commands from the host 110. The controller 140 may comprise a computation unit 142 and a memory unit 144 (e.g. a read-only memory (ROM)). The program codes and data stored in the memory unit 144 may be firmware executed by the computation unit 142, so that the controller 140 may control the flash memory 130 based on the firmware. The flash memory 130 may comprise a plurality of blocks, and each block comprises a plurality of pages.

In an embodiment, the flash memory 130 may comprise a spare block pool 150, and a data block pool 160. The spare block pool 150 comprises a plurality of spare blocks 151-15n for storing invalid data. The data block pool 160 comprise a plurality of data blocks 161-16m for storing data. In an embodiment, the controller 140 may manage the blocks of the flash memory 130 according to the commands from the host 110. A block in the flash memory 130 is assigned based on a physical address, and the host 110 may assign a block based on a logical address. Accordingly, the controller 140 has to convert the logical address from the host 110 to a physical address. In an embodiment, the controller 140 may record the relationship between the logical addresses and physical addresses into an address link table.

In an embodiment, each of the data blocks 161-16m may comprise a plurality of pages. When data is stored in a page of the data blocks, the page can be regarded as a data page. When the page has a corresponding logical address, the page can be regarded as a valid page. In an embodiment, the controller 140 may calculate the number of total valid pages in each of the data blocks 161-16m to obtain a valid page number, and record the valid page number of the data blocks 161-16m to a valid-number table. In addition, the erase count of each block may indicate the number of erasing operations performed on the block. In an embodiment, the controller 140 may record the erase count of each block in the flash memory 130 in an erase-count table. In an embodiment, the flash memory 130 may further comprise the valid-number table and the erase-count table (not shown in FIG. 1).

In an embodiment, when the host 110 writes data to the data storage device 120 consecutively, the number of valid spare blocks in the spare block pool 150 of the flash memory 130 may be small. When the number of spare blocks is lower than the threshold value, the controller 140 may start performing a cleaning procedure (i.e. often referred to as garbage collection) on the flash memory 130.

Specifically, before starting to perform the cleaning procedure, the controller 140 has to determine a clean source block from the data blocks, and determine a clean destination block from the spare blocks. However, if the selected clean source block has too many valid pages, the spare blocks obtained in the cleaning procedure may be fewer in number. In the worst case, the controller 140 has to perform many operations in the cleaning procedure to obtain a complete spare block, resulting in the poor performance of the data storage device 120.

Additionally, when a conventional flash controller performs the cleaning procedure, the data of the valid pages in the source block (i.e. data block) may be copied to a spare page of the destination block (i.e. spare block). For example, in some conventional flash controllers, the data of the valid pages may be completely copied to another spare block without interruption, and the conventional flash controllers cannot respond to other requests during the cleaning procedure. In some other conventional flash controllers, the copying operations of the valid pages may be interrupted by a timer with a predetermined time period, so that the conventional flash controllers may respond to other request after receiving the interruption signal from the timer when the predetermined time period has expired. However, the aforementioned conventional technologies result in a slow response time handling interruptions from the host 110.

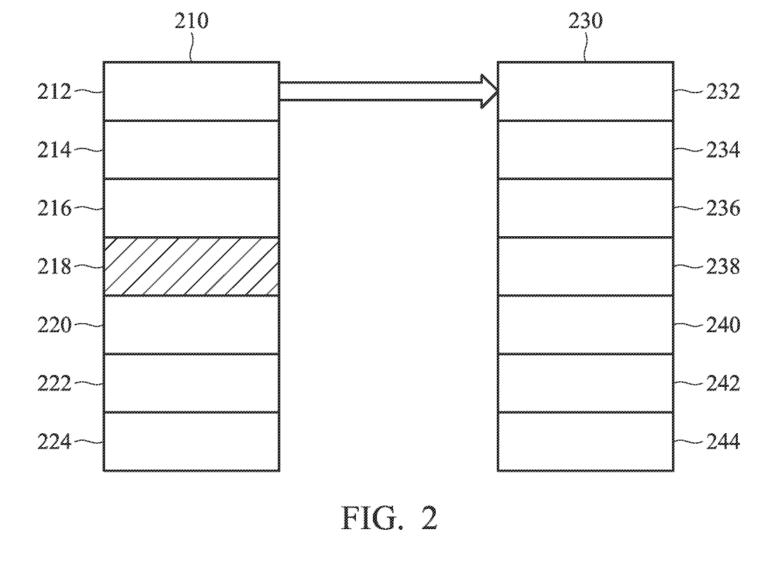

FIG. 2 is a diagram illustrating the copying of a valid page of a source block to a spare block of a destination block in accordance with an embodiment of the invention. In an embodiment, the controller 140 may check whether a request is coming from the host 110 whenever the controller 140 has copied a valid page of the source block to a spare page of the destination block. Since the smallest unit in the operations of a flash memory is a “page”, the fastest response time for handling a request can be guaranteed by the controller 140 of the invention.

For example, as shown in FIG. 2, the controller 140 copies a valid page 212 of a source block 210 to a spare page 232 of a destination block 230, where the empty block denotes as a valid page, and blocks with diagonal lines denotes as invalid pages in the source block 210. Regarding the destination block 230, all the empty blocks are spare pages. When the controller 140 has finished copying the valid page 212, the controller 140 may check whether there is any request from the host 110. If so, the controller 140 may suspend the cleaning procedure and respond to the request from the host 110, and thus the latency to respond to the request from the host 110 can be minimized to the duration of copying a valid page. If not, the controller 140 continues the cleaning procedure. It should be noted that the controller 140 may check for a request from the host 110 whenever the controller 140 has finished copying a valid page, such as valid pages 212, 214, 218 and 220. For those skilled in the art, it will be appreciated that the sizes of a page and a block may vary depending on the design of the flash memory 130, and the latency which the controller 140 responds to a request from the host 110 may also vary based on the size of the page and the data transfer speed. However, the latency to respond to the request from the host 110 is significantly reduced when compared with prior technologies.

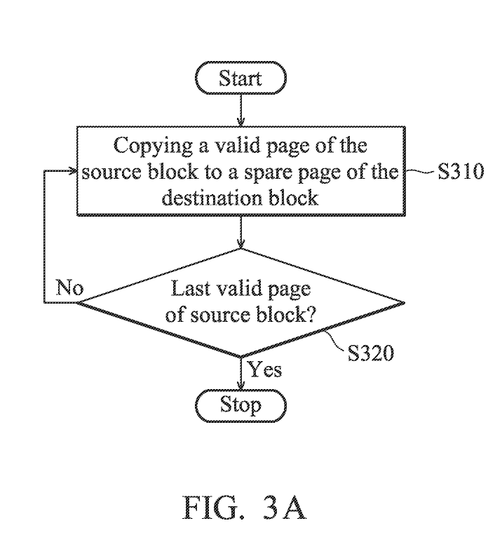

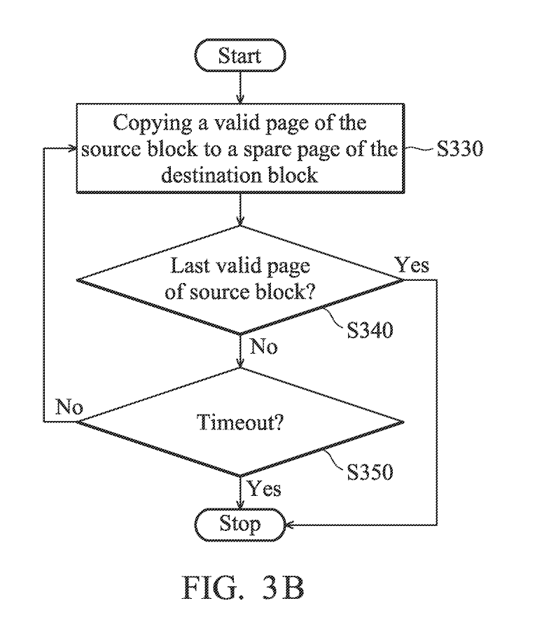

FIG. 3A is a flow chart of a conventional method for responding the request from the host during the cleaning procedure. As shown in FIG. 3A, in step S310, the conventional flash controller copies a valid page of the source block to a spare page of the destination block during the cleaning procedure. In step S320, the conventional flash controller determines whether the valid page is the last page of the source block. If so, the conventional flash controller stops the cleaning procedure. If not, step S310 is performed. It should be noted that the cleaning procedure will not be stopped until all valid pages have been copied to the destination block in the example of FIG. 3A, resulting in a long latency to respond to the request from the host.

FIG. 3B is a flow chart of another conventional method for responding the request from the host during the cleaning procedure. As shown in FIG. 3B, in step S330, the conventional flash controller copies a valid page of the source block to a spare page of the destination block during the cleaning procedure. In step S340, the conventional flash controller determines whether the valid page is the last page of the source block. If the valid page is the last page of the source block, the conventional flash controller stops the cleaning procedure. If the valid page is not the last page of the source block, step S350 is performed. In step S350, the conventional flash controller determines whether a predetermined time period has expired during the cleaning procedure. If so, the conventional flash controller stops the cleaning procedure no matter that the cleaning procedure is not completed yet. If not, step S330 is performed. It should be noted that the conventional flash controller may keep copying valid pages of the source block to the destination block within the predetermined time period. However, the predetermined time period may be long (e.g. hundreds of milliseconds), resulting in a long latency to respond to the request from the host.

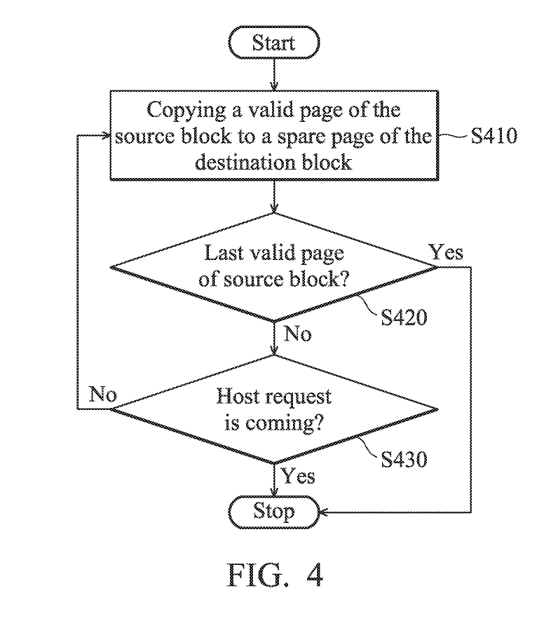

FIG. 4 is a flow chart of a method for interrupting the cleaning procedure of a flash memory in accordance with an embodiment of the invention. As shown in FIG. 4, in step S410, the controller 140 performs the cleaning procedure and copies a valid page of the source block to a spare page of the destination block. In step S420, the controller 140 determines whether the copied valid page is the last valid page of the source block. If so, the controller 140 suspends the cleaning procedure. If not, step S430 is performed. In step S430, the controller 140 determines whether any request is coming from the host 110. If so, the controller 140 suspends the cleaning procedure. If not, step S410 is performed. It should be noted that the controller may continue the cleaning procedure after performing the operations requested by the host 110, so that the memory space of the flash memory can be used efficiently.

In one embodiment, a data storage device is provided. The data storage device includes a flash memory and a controller. The flash memory includes a plurality of data blocks and a plurality of spare blocks. Detail features of the controller have already disclosed in previous paragraphs and will not be mentioned again.

In view of the above, a controller and a method for interrupting a cleaning procedure of a flash memory are provided. The controller and the method are capable of determining whether any request is coming from the host when the controller has finished copying of a valid page of a source block to a spare page of a destination block during the cleaning procedure. When there is a request from the host, the controller may interrupt the cleaning procedure.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A controller for interfacing between a host and a flash memory, wherein the flash memory comprises a plurality of data blocks and a plurality of spare blocks, the controller comprising:
a memory unit; and
a computation unit, configured to perform a cleaning procedure on the flash memory,
wherein whenever the computation unit has finished copying a valid page of a source block in the plurality of data blocks to a spare page of a destination block in the plurality of spare blocks during the cleaning procedure, the computation unit determines whether a request is coming from the host,
if so, the computation unit suspends the cleaning procedure and responds to the request from the host,
if not, the computation unit continues the cleaning procedure.

2. The controller as claimed in claim 1, wherein the computation unit further determines whether the valid page is the last page of the source block before determining whether the request is coming from the host.

3. The controller as claimed in claim 2, wherein the controller further stops the cleaning procedure when the valid page is the last page of the source block.

4. The controller as claimed in claim 1, wherein the request from the host is a write command or a read command to the flash memory.

5. The controller as claimed in claim 1, wherein the controller further continues the cleaning procedure after performing operations of the request from the host.

6. A method for interrupting a cleaning procedure of a flash memory, wherein the flash memory comprises a plurality of data blocks and a plurality of spare blocks, the method comprising:
determining whether a request is coming from the host whenever a valid page of a source block in the plurality of data blocks has been copied to a spare page of a destination block in the plurality of spare blocks during the cleaning procedure;
if so, suspending the cleaning procedure and responding to the request from the host,
if not, continuing the cleaning procedure.

7. The method as claimed in claim 6, further comprising:
determining whether the valid page is the last page of the source block before determining whether the request is coming from the host.

8. The method as claimed in claim 7, further comprising:
stopping the cleaning procedure when the valid page is the last page of the source block.

9. The method as claimed in claim 6, wherein the request from the host is a write command or a read command to the flash memory.

10. The method as claimed in claim 6, further comprising:
continuing the cleaning procedure after performing operations of the request from the host.

11. A data storage device, comprising:
a flash memory comprising plurality of data blocks and a plurality of spare
a controller, interfacing between a host and the flash memory, wherein the controller comprises:
a memory unit; and
a computation unit, configured to perform a cleaning procedure on the flash memory,
wherein whenever the computation unit has finished copying a valid page of a source block in the plurality of data blocks to a spare page of a destination block in the plurality of spare blocks during the cleaning procedure, the computation unit determines whether a request is coming from the host,
if so, the computation unit suspends the cleaning procedure and responds to the request from the host,
if not, the computation unit continues the cleaning procedure.

12. The data storage device as claimed in claim 11, wherein the computation unit further determines whether the valid page is the last page of the source block before determining whether the request is coming from the host.

13. The data storage device as claimed in claim 12, wherein the controller further stops the cleaning procedure when the valid page is the last page of the source block.

14. The data storage device as claimed in claim 11, wherein the request from the host is a write command or a read command to the flash memory.

15. The data storage device as claimed in claim 11, wherein the controller further continues the cleaning procedure after performing operations of the request from the host.
